(19) United States
(12) Patent Application Publication
(10) Pub. No.: US 2003/0036921 A1
(43) Pub. Date: Feb. 20, 2003

(54) Consultant server and consultation method

(76) Inventors: Atsushi Ito, Asaka-shi (JP); Tomoyuki Hasegawa, Tokyo (JP); Iwao Kawashima, Tokyo (JP); Kanji Nakanishi, Asaka-shi (JP); Koki Okamura, Asaka-shi (JP); Norihisa Haneda, Asaka-shi (JP)

Correspondence Address: BIRCH STEWART KOLASCH & BIRCH, PO BOX 747, FALLS CHURCH, VA, 22040-0747, US

(21) Appl. No.: 10/218,576

(22) Filed: Aug. 15, 2002

(30) Foreign Application Priority Data
Aug. 15, 2001 (JP) NO.2001-246540

(51) Int. Cl. G06F 17/60

(52) U.S. Cl. 705/1

(57) ABSTRACT

The consultant server and the consultation method are provided for fixing a user's fee and a rating for each service, notifying the user of the information, and allocating the user's fee among service providers based on the rating when a user obtains a service via the Internet. The consultant server includes a sending/receiving device by which evaluation information input by a user who has obtained a service, a information-processing device which fixes a user's fee and a rating for each service based on the evaluation information, a sending/receiving device which sends information about the above described user's fee and rating for each service to a user's personal computer and the like, an information-processing device which allocates user's fees for services among service providers based on the rating.

### BACKGROUND OF THE INVENTION

1. Field of the Invention

The present invention relates to a consultant server and a consultation method and, more particularly, to a consultant server and a consultation method that acquires and aggregates evaluation information for services implemented by a service provider who provides services such as article sales or diagnosing services on an affected part of a patient, and outputting the aggregated result to a user and the like.

2. Description of the Related Art

A system has already been known that, over the Internet, a user has estimated of an article or services that he/she wants to buy or obtain, and then he/she places an order for the article or the service with a provider of which condition he/she judged the most favorable.

However, users have great demand for knowing certainty about outcome of each service or reputation of each service provider, when users are considering getting services such as consulting on an image with respect to palmistry, physiognomy, or medical services. In contrast, service providers have great demand for knowing reputation of services that they have provided.

### SUMMARY OF THE INVENTION

The present invention is adapted in view of the above-described circumstances. The present invention is intended to provide a consultant server and a consultation method which can acquire evaluation information of a user's judgment on a service which he/she has already obtained, can fix a user's fee and a rating for each service based on the evaluation information, can provide the information to users and the like, and can allocate user's fees for services among service providers according to each ratings when users obtain a variety of services over a communication line such as the Internet.

To achieve the above described purpose, the present invention provides a consultant server that acquires and aggregates evaluation information for a service provided by a service provider who provides a service such as article sales or diagnosing services on an affected part of a patient, and outputs the aggregated result to users and the like, wherein it comprises a receiving device which receives evaluation information for a service provided by a service provider, a fee calculation device which calculates a user's fee for each service provided by service providers based on the received evaluation information for services, and a sending device which sends the calculated fee for each service to another communication device.

According to the present invention, there is provided a receiving device which receives evaluation information for a service provided by a service provider, a fee calculation device which calculates a user's fee for each service provided by service providers based on the received evaluation information for services, and a sending device which sends the calculated fee for each service to another communication device, allowing a user's fee, a rating and the like for each services to fit based on the evaluation information and notify users and the like of the information.

### BRIEF DESCRIPTION OF THE DRAWINGS

The nature of this invention, as well as other objects and advantages thereof, will be explained in the following with reference to the accompanying drawings, in which like reference characters designate the same or similar parts throughout the figures and wherein:

FIG. 1 shows an exemplary configuration of a system when a consultant server according to the present invention is applied to a fortune-telling service;

FIG. 2 shows a block diagram for a signal processing system of a server; and

FIG. 3 shows an exemplary display of a service site selection screen.

### DETAILED DESCRIPTION OF THE PREFERRED EMBODIMENTS

Preferred embodiments of a consultant server and a consultation method according to the present invention will now be described in detail with reference to attached drawings.

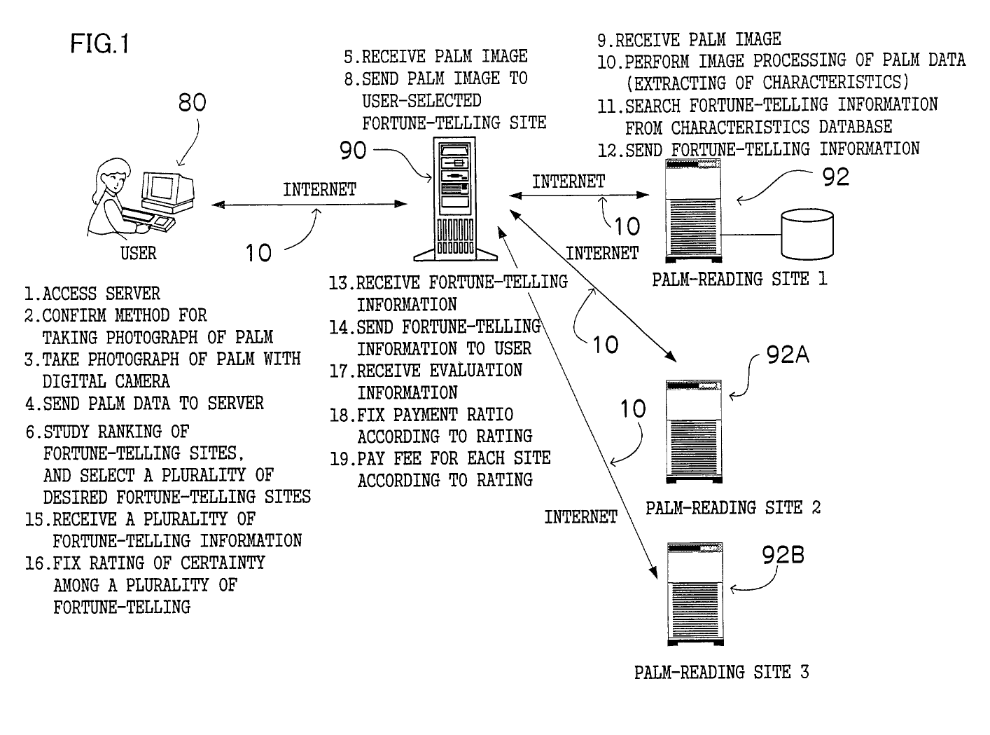

FIG. 1 shows an exemplary configuration of a system when a consultant server according to the present invention is adapted to a fortune-telling service.

According to FIG. 1, a consultant system for fortune-telling is provided with a personal computer 80 which sends information required for obtaining a service such as an image and fortune-telling or information about evaluation of a service over a communication line 10 such as the Internet and can receives and displays service information such as a consultant information or results of fortune-telling or diagnosing, a server 90 (a consultant server) which receives evaluation information for fortune-telling, a diagnosis and the like over a communication line 10 and calculates a rating for each service providers based on the received service evaluation information and calculates a fee from the rating for each service, and service sites (service providers) 92, 92A, 92B . . . etc. which provide a variety of services such as article sales or a diagnosing service on an affected part of a patient.

A server 90 has functions of acquiring and aggregating evaluation information for services provided by service providers who provide services such as article sales or diagnosing services on an affected part of a patient, and outputting the aggregated result to users and the like.

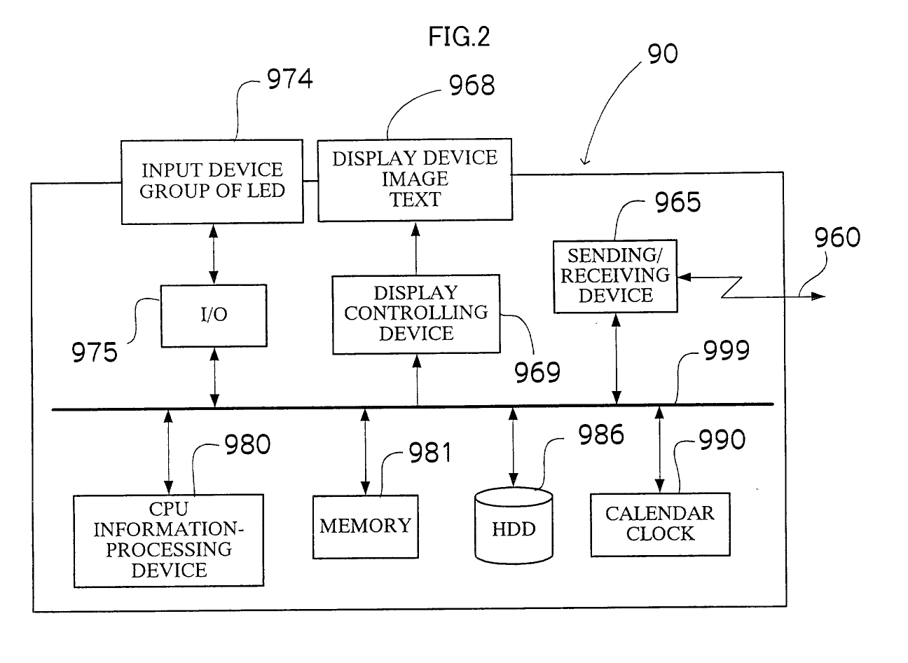

FIG. 2 is a block diagram of a signal processing system of a server.

According to FIG. 2, an information sending/receiving unit in a server 90 is provided with a sending/receiving device 965 (including functions of a sending device, a first sending device, a second sending device, a third sending device, a receiving device, a first receiving device, a second receiving device, and a third receiving device) for sending and receiving information with another communication device (a personal computer 80, a service site 92, etc.) over a public network 960 or a communication line 10 such as a communication network.

A server 90 is also provided with a display device 968 which displays information such as image or text for confirmation if needed, a display controlling device 969 which outputs an image signal for a display to the display device 968 according to the command from an information-processing device, and an I/O 975 which reads various pieces of information input by an administrator through an input device 974 in order to send that information to an information-processing device that will be described below or outputs a display command to a notifying device such as LED according to a designation from a information-processing device.

In addition, a server 90 is also provided with a information-processing device (CPU) 980 which controls an entire server 90, a memory 981 that includes a ROM in which a program for operating the information-processing device 980 or various constants are recorded and a RAM which is a recording device to serve as working area when the information-processing device 980 performs processing, a recording device 986, for example, a hard disk which records information such as connecting information including various constants for processing of a server 90, information about own attribution on the network, URL (Uniform Resource Locators), address, site address, and gateway information DNS (Domain Name System), and a calendar clock 990 which keeps time.

An information-processing device 980 and respective peripheral circuits including a display controlling device 969, an I/O 975, a memory 981, a recording device 986, a calendar clock 990, etc. are connected via a bus 999, allowing the information-processing device 980 to control each of the peripheral devices.

The above described sending/receiving device 965 can receive, from a user's personal computer 80 and the like, one or more pieces of evaluation information for services that have been provided by a service provider (service site 92) to a user.

The information-processing device 980 (a fee calculation device) has a function of calculating a user's fee for each service provided by service providers (service site 92, etc.) based on one or more pieces of evaluation information about services received from a user's personal computer 80 and the like by a sending/receiving device 965. The information-processing device 980 (a ranting device) also has a function of fixing a rating of quality of respective services provided by a service provider based on a plurality of pieces of evaluation information for services received from a user's personal computer 80 by a sending/receiving device 965.

Moreover, the information-processing device 980 (a settlement device) can settle a price for the service based on the information to the effect that a user pays the user's fee for the service that the user has received from a communication device on the user's side (a personal computer 80) by a sending/receiving device 965. Then, the user's fee can be allocated to each service provider based on rating.

The above described sending/receiving device 965 has a function of sending information about a service fee and a rating of service quality (a rating) calculated by an information-processing device 980 to another communication device (a user's personal computer 80 or a server at a service site 92).

A recording device 986 can record information about a user's fee and a rating for each service calculated by an information-processing device 980.

A consultation method for a palm reading service using a consultant server according to the present invention will now be described below.

As shown in FIG. 1, in the first place, a user operates his/her personal computer 80 to start accessing a server 90 to have his/her palm read. From the server 90, a display file including information that prompts the user to select from a plurality of service sites 92, 92A, and 92B, which provide palm reading services, along with user's fee for the services is sent to the personal computer 80. After receiving the display file, the personal computer 80 displays information, which prompts the user to select respective service sites, on a display device and notify the user of the information.

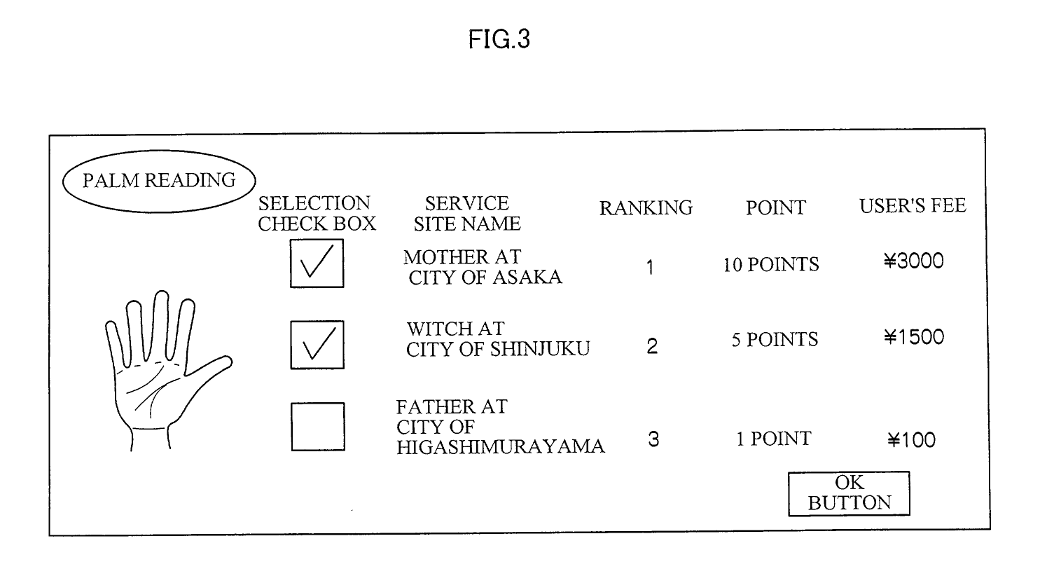

FIG. 3 shows a display example of a service site selection screen that is displayed on a display device of a personal computer 80 when a user selects service sites.

As shown in the FIG. 3, on a service site selection screen, a contents which tells that a service to be selected is “palm reading”, a service site name which tells names of the service sites 92 (service providers) etc., a user's fee which is calculated by an information-processing device 980 in a server 90 for each service site, a ranking and a point according to a rating of each service, a selection check box for a user to check and to input information about a service site which he/she wants to use, and an OK button are displayed.

If this service is used for the first time, a user's fee for the service is set as a standard fee (a basic fee set by a service site 92) without attaching any information about a rating and a point of the service.

After selecting a desired service and a service site thereof and choosing an OK button, the user confirms the method of taking a palm photograph. If the user uses a digital camera, then he/her selects a method of taking a palm photograph with a digital camera. The image data of a palm taken by the user with a digital camera is sent from a personal computer 80 to a server 90 via a communication line 10 such as the Internet.

If a display device of the personal computer 80 includes information about a user's fee and a rating for each service based on quality of services provided by a plurality of service sites 92, 92A, 92B etc. (certainty of a fortune told, information about satisfaction by prior users, etc.), the user may select his/her desired service site with reference to the information. The user may also select a plurality of service sites and obtain a plurality of fortune-telling services to compare respective fortunes told to his/her satisfaction.

A sending/receiving device 965 in the server 90 sends the palm image received from the personal computer 80 again via a communication line 10 such as the Internet to a user-selected predetermined service site 92 (palm reading site 1), or a plurality of service sites 92, 92A, 92B and the like selected by the user. The service site 92 and the like receive image data of a palm which has sent from the server 90, then an information-processing device included in the service site 92 or so processes the image.

For example, an information-processing device of a service site 92 extracts the characteristic portion of the received image data of a palm, then searches and reads out the referential palm-reading information for the extracted characteristic portion from a characteristics database of a recording device within the service site 92 and compares them.

When an information-processing device of the service site 92 searches the most resembled referential palm image from a characteristics database, the device reads out the searched palm-reading information for the palm image (consult information) from the recording device and sends the information to a server 90.

A sending/receiving device 965 in the server 90, which has received the above described palm-reading information (consult information) from a service site 92 and the like, converts the above described received palm-reading information into a display file format which can be displayed on a display device of a user's personal computer 80 and sends the converted information to the user's personal computer 80 via the sending/receiving device 965.

A personal computer 80, which has received the palm-reading information consulted by a user's desired service site, displays the received palm-reading information on a display device to notify a user of the information. If a user selects a plurality of service sites 92, 92A, 92B and the like and designates fortune-telling, fortunes told by a plurality of service sites are displayed on the display device.

Then the user inputs evaluation information for the fortune-telling such as comments, marks, preferences, satisfaction, rating for the fortune told in terms of certainty, experienced satisfaction converted into price and so on for each of a plurality of fortunes displayed, if required, and commands to send that information toward the server 90.

The server 90 receives the above described evaluation information for a service via the sending/receiving device 965. An information-processing device 980 (a fee calculation device) further calculates user's fees for each service provided by the service provider (a service site 92, etc.) based on one or more pieces of evaluation information which the sending/receiving device received from the user's personal computer 80 or so. The information-processing device 980 (a rating device) rates quality of respective services provided by service providers based on a plurality pieces of evaluation information for services which the sending/receiving device 965 has received from the user's personal computer 80. A recording device 986 may record information about a user's fee and a rating for each service that are calculated by an information-processing device 980.

The information about a user's fee and a rating for each service that are calculated by the above described information-processing device 980 is sent to the personal computer 80 when a user desires to use that service for the next time, and is displayed on a display device of a user's personal computer 80 as a consultant information for the service (as a service site selection screen) to be notified to the user.

The information about a user's fee and a rating for each service that are calculated by the above described information-processing device 980 may also be sent back to each service site such as 92, 92A, 92B and the like so as to feedback the information into the contents of each business as a reputation of each service site. According to the information about a user's fee and a rating for each service that are calculated by the above described information-processing device 980, the user's fee paid for each service site 92, 92A 92B etc. may be fixed to make each service site be paid each allot. Generally, a service site (a service provider) with higher reliability and better reputation is paid higher user's fee.

Conventional services have a problem that a reputation of a service provided by each service site (a service provider) is not clear (it is uncertain) for users. In addition, it is not easy for each service site to recognize reputation of other service sites which provide competing services as well as its own reputation, which leads another problem of halting an improvement of the service. However, by using a consultant server and a consultation method according to the present invention, useful information both for users and for service sites can be provided.

Accordingly, running costs of the consultant server may be claimed either from a user or from a service provider (service site, etc.).

The present invention is not limited to such purposes as the above described fortune-telling services. A consultant server and a consultation method according to the present invention may be applied to the case of providing such services as teacher's correction in a correspondence education, a template composing service with an image taken by a user, a correction service such as touching-up marks, an image processing service, a reading service or a diagnosis service of a medical image of an affected part, an information analysis service, a general article sales, and providing of a general services.

A consultation method for a diagnosing service using a consultant server according to the present invention will now be described below.

In the first place, a user operates his/her personal computer 80 to start accessing a server 90 to have an affected part of a patient diagnosed. From the server 90, a display file including information that prompts the user to select from a plurality of service sites, which provide a diagnosis on an affected part of a patient, along with user's fee for the services is sent to the personal computer 80. After receiving the display file, the personal computer 80 displays information, which prompts the user to select respective service sites, on a display device and notify the user of the information.

A service site selection screen is displayed on a display device of a personal computer 80. On the service site selection screen, for example, a contents which tells that a service to be selected is “diagnosis”, a service site (service providers) name which tells names of sites for a diagnosing service, a user's fee which is calculated by an information-processing device 980 in a server 90 for each service site, a ranking and point according to a rating of a service, a selection check box for a user to check and input information about a service site which he/she wants to use, and an OK button are displayed.

If this service is used for the first time, a user's fee for the service is set as a standard fee (a basic fee set by a service site) without attaching any information about a rating and a point of the service.

After selecting a desired service and a service site thereof and choosing an OK button, the user confirms the method of taking a photograph of an affected part. If the user uses a digital camera, then he/her selects a method of taking a photograph of an affected part with a digital camera. The image data of the affected part taken by the user with a digital camera is sent from a personal computer 80 to a server 90 via a communication line 10 such as the Internet.

If a display device of a personal computer 80 includes information about a user's fee and a rating for each service based on quality of services provided by a plurality of service sites (certainty of a diagnosis, information about satisfaction by prior users, etc.), the user may select his/her desired service site with reference to the information. The user may also select a plurality of service sites and obtain a plurality of diagnoses to compare respective diagnoses.

A sending/receiving device 965 in a server 90 sends an image of an affected part of a patient from the personal computer 80 again via a communication line 10 such as the Internet to a user-selected predetermined service site 92 (a diagnosis service site), or a plurality of service sites selected by a user. The above described service site which has received an image of an affected part of a patient performs an image processing for the received image.

For example, an information-processing device of a service site extracts a characteristic portion of the received image data of an affected part, then searches and reads out a referential image for the extracted characteristic portion from a characteristics database of a recording device within a service site 92 and compares them.

When an information-processing device of a service site searches the most resembled referential image of an affected part from a characteristics database, the device reads out the searched diagnosis information on the affected part (consult information) from the recording device and sends the information to a server 90.

A sending/receiving device 965 in a server 90, which has received the above described diagnosis information (consult information) from a service site and the like, converts the above described received diagnosis information into a display file format which can be displayed on a display device of a user's personal computer 80 and sends the converted information to the user's personal computer 80 via a sending/receiving device 965.

A personal computer 80, which has received the diagnosis information on an affected part from the user's desired service site, displays the received diagnosis information on a display device and notifies a user of the information. If a user selects a plurality of service sites and designates a diagnosis on an affected part, diagnoses from a plurality of service sites are displayed on a display device.

Then the user inputs evaluation information for the diagnosis such as comments, marks, preferences, satisfaction, ratings for the diagnosis in terms of certainty, experienced satisfaction converted into price and so on for each of a plurality of diagnoses displayed, if required, and commands to send that information toward the server 90.

The server 90 receives the above described evaluation information for a service via a sending/receiving device 965. An information-processing device 980 (a fee calculation device) further calculates a user's fee for each service provided by the service provider (a service site 92, etc.) based on one or more pieces of evaluation information which a sending/receiving device 965 received from the user's personal computer 80 or so. The information-processing device 980 (a rating device) rates quality of respective services provided by service providers based on a plurality pieces of evaluation information for services which a sending/receiving device 965 has received from a user's personal computer 80. A recording device 986 may record information about a user's fee and a rating for each service that are calculated by an information-processing device 980.

The information about a user's fee and a rating for each service that are calculated by the above described information-processing device 980 is sent to the personal computer 80 when a user desires to use that service for the next time, and is displayed on a display device of a user's personal computer 80 as a consultant information for the service (as a service site selection screen) to be notified to the user.

The information about a user's fee and a rating for each service that are calculated by the above described information-processing device 980 may also be sent back to each service site that has provided a diagnosis so as to feedback the information into the contents of each business as a reputation of each service site. According to the information about a user's fee and a rating for each service that are calculated by the above described information-processing device 980, the user's fee to be paid for each service site that has provided a diagnosis may be fixed to make each service site be paid own allot. Generally, a service site (a service provider) with higher reliability and better reputation is paid higher user's fee.

Conventional diagnosing services have a problem that a reputation of a diagnosing service provided by a plurality of clinics is not clear (it is uncertain) for users, because a diagnosis can be provided by only one clinic at a time. To make matters worse, if a patient consults two different clinics and acquires two different diagnoses, the patient would significantly anxious about his/her illness. This would make the patient visit a third clinic to have diagnosed for confirmation, which would lead inconclusive pilgrimage to clinics. In addition, it is not easy for each clinic to recognize reputation of other clinics, which provide competing services, as well as its own reputation; this leads another problem of halting an improvement of the service. However, by using a consultant server and a consultation method according to the present invention, useful information both for users and for clinics can be provided. Although the present invention is illustrated with an example that provides diagnosis automatically at a medical site in the above described embodiment, the present invention should not be limited to the method for providing a diagnosis automatically. The object of the present invention can be achieved in the way that a doctor in attendance views an image of an affected part of a patient displayed on a display device of a service site and diagnoses on the image, inputs the diagnosis through a input device in a server of a service site, then sends the diagnosis to a server 90.

Although the present invention is illustrated by an example that a server (a consultant server) performs a consultation service, the present invention should not be limited to a server. The present invention can be achieved as an automatic dispenser-style vending machine in a store that can send and receive information among respective service sites via a communication line such as the Internet to perform the above described consultant.

In the above described case, a user inputs information for obtaining a service through an input device provided for the vending machine in a store, and selects his/her desired service site by viewing consultant information displayed on a display device of the vending machine in the store. If the provided service is the fortune-telling, a fortune told by a user-selected service site is displayed on a display device of the vending machine in a store. If the provided service is a diagnosis, a diagnosis provided by a user-selected service site is displayed on a display device of the vending machine in a store. If the service selected by a user is purchase of an article, a user-selected article is delivered to the user's home and the like.

As mentioned above, a consultant server according to the present invention may fix a user's fee or a rating for each service based on the evaluation information and notify users and the like of that, because it comprises a receiving device which receives evaluation information for services provided by a service provider, a fee calculation device which calculates a user's fee for each service provided by the service provider based on the above described received evaluation information for services, a sending device which sends the above described calculated user's fee for each service to another communication device.

It should be understood, however, that there is no intention to limit the invention to the specific forms disclosed, but on the contrary, the invention is to cover all modifications, alternate constructions and equivalents falling within the spirit and scope of the invention as expressed in the appended claims.

What is claimed is:

1. A consultant server which acquires and aggregates evaluation information for a service provided by a service provider who provides article sales or services, and outputs the aggregated result to a user and the like, the consultant server comprising:
a first receiving device which receives an image information which is subject to a service as well as information to the effect that a user will pay a user's fee for the service from a communication device on the user's side via a communication line;
a first sending device which sends the received image information to a plurality of service providers via a communication line;
a settlement device which settles the price of the service based on the received information to the effect that a user will pay a user's fee for the service;
a second receiving device which receives a plurality pieces of consultant information based on the image information that is sent to service providers from a plurality of service providers via a communication line;
a second sending device which sends the plurality pieces of consultant information that is received from a plurality of service providers to a communication device on the user's side;
a third receiving device which receives evaluation information for plurality of services that is provided by service providers from a communication device on the user's side;
a rating device which fixes a rating for each service that is provided by a plurality of service providers based on the received plurality of evaluation information; and
a third sending device which sends the fixed rating to a communication device on the user's side.

2. The consultant server according to claim 1, further comprising a fee calculation device which calculates a user's fee for each service that is provided by the service providers based on the received evaluation information, wherein the third sending device sends the calculated user's fee for each service to a communication device on the user's side.

3. The consultant server according to claim 2, wherein the first receiving device receives information to the effect that a user will pay a user's fee for a service after the third sending device has sent the calculated user's fee for each service to a communication device on the user's side.

4. A consultant server which acquires and aggregates evaluation information for a service provided by a service provider who provides a diagnosing service on an affected part of a patient, and outputs the aggregated result to a user and the like, the consultant server comprising:
a first receiving device which receives an image information of an affected part of a patient which is subject to a service as well as information to the effect that a user will pay a user's fee for the service from a communication device on the user's side via a communication line;
a first sending device which sends the received image information of an affected part of a patient to a plurality of service providers via a communication line;
a settlement device which settles the price of the service based on the received information to the effect that a user will pay a user's fee for the service;
a second receiving device which receives a plurality pieces of consult information based on the image information of an affected part of a patient that is sent to the service providers from a plurality of service providers via a communication line;
a second sending device which sends the plurality pieces of consult information that is received from a plurality of service providers to a communication device on the user's side;
a third receiving device which receives evaluation information for plurality of services that is provided by service providers from a communication device on the user's side;
a rating device which fixes a rating for each service that is provided by a plurality of service providers based on the received plurality of evaluation information; and
a third sending device which sends the fixed rating to a communication device on the user's side.

5. The consultant server according to claim 4, further comprising a fee calculation device which calculates a user's fee for each service that is provided by the service providers based on the received evaluation information, wherein the third sending device sends the calculated user's fee for each service to a communication device on the user's side.

6. The consultant server according to claim 5, wherein the first receiving device receives information to the effect that a user will pay a user's fee for a service after the third sending device has sent the calculated user's fee for each service to a communication device on the user's side.

7. A consultant server which acquires and aggregates evaluation information for each service provided by a service provider who provides article sales or a service such as diagnosis on an affected part of a patient, and outputs the aggregated result to a user and the like, the consultant server comprising:
a receiving device which receives evaluation information for each service that is provided by a service provider;
a fee calculating device which calculates a user's fee for each service that is provided by the service provider based on the received evaluation information for each service; and
a sending device which sends the calculated user's fee for each service to another communication device.

8. A consultant server which acquires and aggregates evaluation information for each service provided by a service provider who provides article sales or a service such as diagnosis on an affected part of a patient, and outputs the aggregated result to a user and the like, the consultant server comprising:
a receiving device which receives evaluation information for a plurality of services that is provided by a service provider;
a fee calculating device which calculates a user's fee for each service that is provided by a service provider based on the plurality pieces of received evaluation information for each service; and
a sending device which sends the calculated user's fee for each service to another communication device.

9. The consultant server according to claim 8, further comprising a rating device which fixes a rating for each service that is provided by service providers based on the received plurality pieces of evaluation information, wherein the sending device sends the fixed rating for each service to another communication device.

10. A consultation method for acquiring and aggregating evaluation information for each service provided by a service provider who provides article sales or a service such as diagnosis on an affected part of a patient, and outputting the aggregated result to a user and the like,
wherein the method uses a consultant server comprising a receiving device which receives evaluation information for each service, a fee calculating device which calculates a user's fee for each service, and a sending device which sends the calculated user's fee for each service to another communication device,
wherein the method comprises:
a receiving step that the receiving device receives evaluation information for each service that is provided by a service provider;
a calculating step that the fee calculating device calculates a user's fee for each service provided by the service provider based on the received evaluation information for each service; and
a sending step that the sending device sends the calculated user's fee for each service to another communication device.
